(19) United States
(12) Patent Application Publication
(10) Pub. No.: US 2010/0011536 A1
(43) Pub. Date: Jan. 21, 2010

(54) HINGE MECHANISM FOR FOLDABLE ELECTRONIC DEVICE

(75) Inventor: HAO-SIAN LIN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/482,554

(22) Filed: Jun. 11, 2009

(30) Foreign Application Priority Data
Jul. 21, 2008 (CN) 200810302868.1

(51) Int. Cl. E05F 1/12; E05F 1/08

(52) U.S. Cl. 16/291; 16/277

(57) ABSTRACT

A hinge mechanism for interconnecting a cover and a main body of a foldable electronic device, includes a sleeve, a shaft unit, an elastic member and an engaging body. The sleeve has two opposite gaps formed in the interior wall thereof, the shaft unit includes a shaft portion and an end portion formed at an end of the shaft portion, the shaft portion defines a slot therein, the elastic member includes a central wall and two opposite flanges. The shaft unit, the elastic member and the engaging body are mounted into the sleeve, the slot receives the central wall and the two flanges extends into the two gaps correspondingly, the shaft portion is fixed with the engaging body, the elastic member urges the shaft unit return to original position when the shaft unit rotates relative to the sleeve.

### BACKGROUND

1. Technical Field

The present disclosure generally relates to hinge mechanisms and, more particularly, to a hinge mechanism for a foldable electronic device.

2. Description of Related Art

With the development of the technologies of wireless communication and information processing, portable electronic devices such as mobile phones and notebooks are now in widespread use. Foldable electronic devices are particularly favored by consumers for their convenience. Generally, foldable electronic devices have a main body and a cover. Various types of hinge mechanisms are used to join the main body to the cover of the foldable electronic device, so that the cover can unfold away from and fold to the main body.

A typical hinge mechanism includes a shaft, a cam, a follower engaging with the cam, and a spring. The cam, the follower, and the spring are mounted on the shaft and the spring resists one of the cam or the follower. The cam is fixed to one of the main body and the cover, correspondingly, the follower is fixed to the other of the cover or the main body. To fold the cover to the main body, the cover is manually rotated to a predetermined angle, then, without further exertion of force, the spring takes over to urge the cover to fold to the main body. However, the hinge mechanism can be complex in structure, and time-consuming to assemble.

Therefore, there is room for improvement within the art.

### BRIEF DESCRIPTION OF THE DRAWING

Many aspects of the present hinge mechanism for a foldable electronic device can be better understood with reference to the following drawings. The components in the drawings are not necessarily drawn to scale, the emphasis instead being placed upon clearly illustrating the principles of the present hinge mechanism for foldable electronic device. Moreover, in the drawings, like reference numerals designate corresponding parts throughout the several views.

FIG. 1 is an exploded, isometric view of a hinge mechanism according to an exemplary embodiment.

FIG. 2 is sectional, isometric view of the shaft of the hinge mechanism shown in FIG. 1.

FIG. 3 is an assembled, cut-away, isometric view of the hinge mechanism shown in FIG. 1.

FIG. 4 is an exploded, isometric view of a foldable electronic device using the hinge mechanism shown in FIG. 1.

FIG. 5 is an assembled, isometric view of the foldable electronic device shown in FIG. 4.

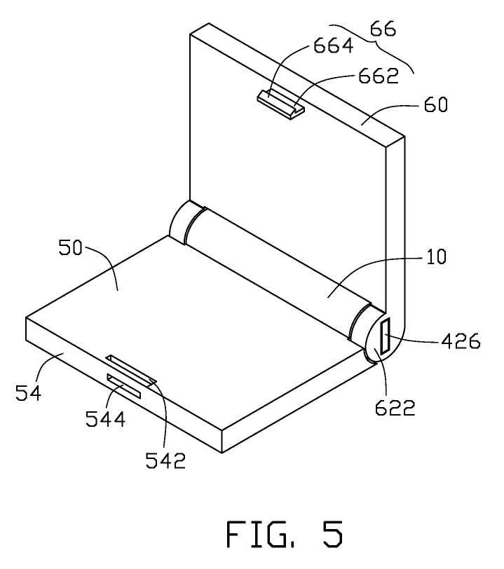

### DETAILED DESCRIPTION

The present hinge mechanism is suitable for a foldable electronic device such as a foldable mobile phone. It is to be understood that the hinge mechanism can also be used in other apparatuses (e.g., cabinet doors).

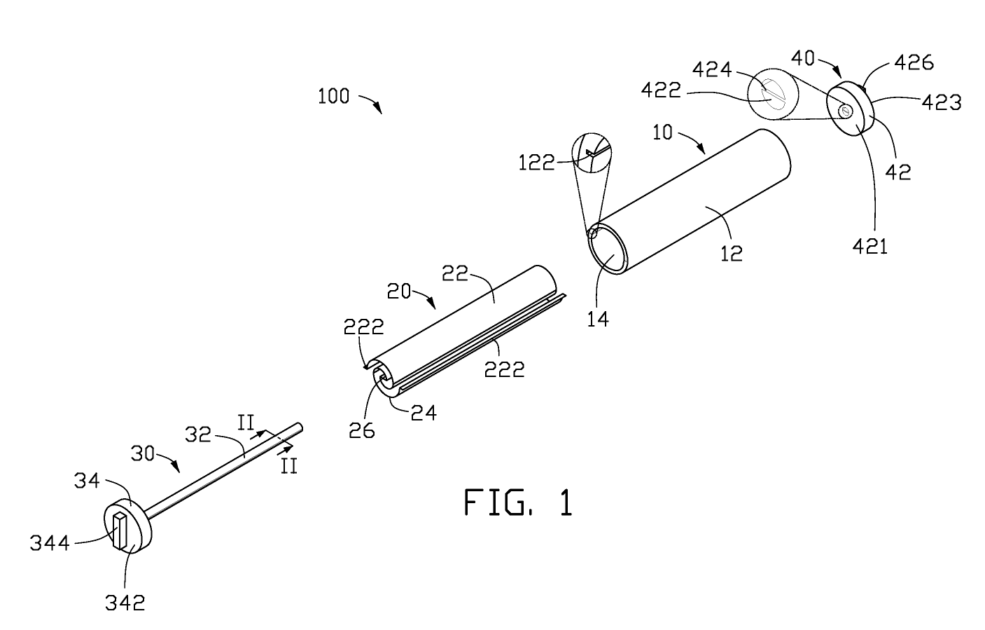

Referring to FIG. 1, a hinge mechanism 100 includes a sleeve 10, an elastic member 20, a shaft unit 30, and an engaging body 40.

The sleeve 10 is tubular including a tube wall 12 and a space 14. The tube wall 12 defines two opposite gaps 122 in the interior wall thereof, the gaps 122 are configured for securely engaging with the elastic member 20.

The elastic member 20 is a flat spring, generally dual helical in shape, including a first helical member 22, a second helical member 24, and a central wall 26 connecting the first helical member 22 to the second helical member 24. Each of the first helical member 22 and the second helical member 24 forms a flange 222 on an exposed longitudinal edge. The two flanges 222 are oppositely arranged and configured for being received into the two gaps 122 of the sleeve 10. The central wall 26 is located in the center of the elastic member 20 and extends along the central axis of the elastic member 20. The central wall 26 is received in the shaft unit 30.

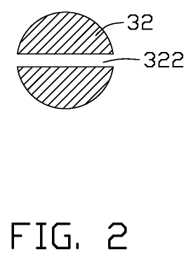

Referring further to FIG. 2, the shaft unit 30 includes a shaft portion 32 and an end portion 34 formed at an end of the shaft portion 32. The shaft portion 32 defines a slot 322 extending along the axis of shaft portion 32 and dividing the shaft portion 32 into two shaft sections. The slot 322 is configured for receiving the central wall 26 of the elastic member 20. The end portion 34 has the same shape and size as the space 14. An end surface 342 of the end portion 34 has a protrusion 344 protruding therefrom opposite to the shaft portion 32. The protrusion 344 is configured to connecting to one of a main body and a cover of the foldable electronic device.

The engaging body 40 includes a main portion 42 having a first surface 421 and a opposite second surface 423. The main portion 42 has the same shape and size as the space 14 and thus can be received into the space 14. The first surface 421 has a central circular cavity 422 for receiving the distal end of the shaft portion 32. The circular cavity 422 receives a dividing wall 424 extending along the diameter thereof. The dividing wall 424 divides the circular cavity 422 into two semi-circular cavities (not labeled). The extension width of the dividing wall 424 is equal to the width of the slot 322. An engaging portion 426 protrudes from the second surface 423 for affixing the engaging body 40 to the other one of the cover and the main body.

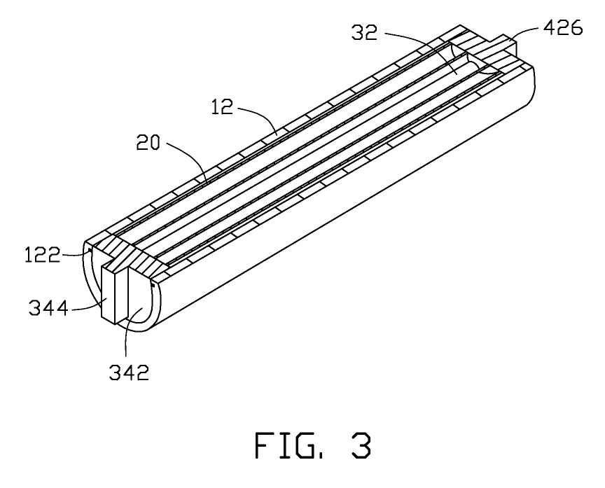

Referring to FIG. 3, to assemble the hinge mechanism 100, the elastic member 20 can be inserted into the sleeve 10, the two flanges 222 of the elastic member 20 extend into the gaps 122 of the tube wall 12. Then, the shaft portion 32 is inserted into the space 14 of the sleeve 10 until the end of the sleeve 10 is enclosed by the end portion 34 of the shaft unit 30. In this case, the protrusion 344 of the end portion 34 is located outside of the sleeve 10, the slot 322 of the shaft portion 32 receives the central wall 26 of the elastic member 20. After that, the engaging body 40 is mounted into the sleeve 10 at the end opposite to the end portion 34. At this time, the shaft portion 32 enters into the circular cavity 422, and the shaft portion 32 clips onto the dividing wall 424 therein by way of the slot 322. The engaging portion 426 is exposed outside of the sleeve 10.

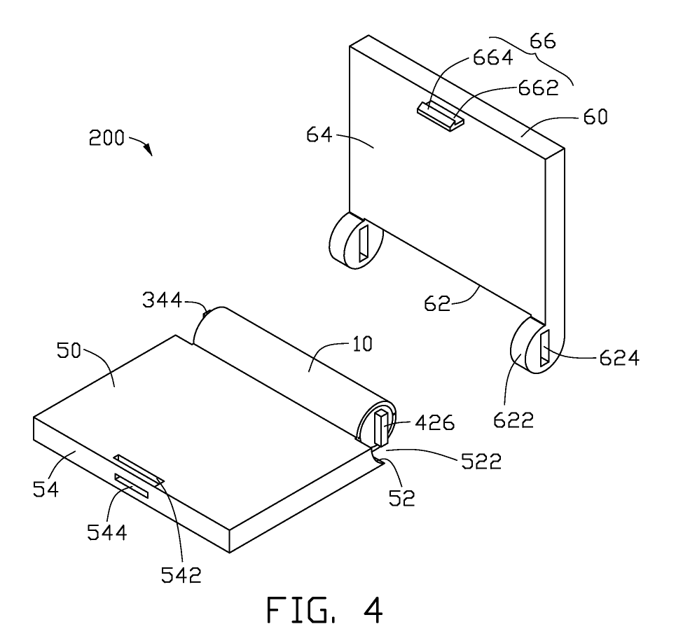

FIG. 4 shows the hinge mechanism 100 assembled with an electronic device 200 including a main body 50 and a cover 60. The main body 50 includes a first sidewall 52 integrally fixed with the sleeve 10 and a second sidewall 54 opposite to the first sidewall 52. The first sidewall 52 is longer than the sleeve 10, and the sleeve 10 is positioned at the middle of the first sidewall 52, and thus two receiving spaces 522 are defined adjacent to the first sidewall 52 corresponding to the two ends of the sleeve 10. When the hinge mechanism 100 is assembled, the protrusion 344 and the engaging portion 426 are secured in the receiving spaces 522 respectively. The main body 50 further defines a notch 542 adjacent to the second sidewall 54 and a latching hole 544 in the second sidewall 54 communicating with the notch 542. The latching hole 544 is configured to receive a latching portion of the cover 60 thereinto.

The cover 60 includes a connecting sidewall 62 and a bottom wall 64. The connecting sidewall 62 has two seats 622 integrally formed for affixing the cover 60 to the main body 50 by a securing of the two seats 622 with the hinge mechanism 100. The seat 622 is elastic and can be deformed by an external force. Each of the seats 622 defines an aperture 624 for securing one of the protrusion 344 and the engaging portions 426. The cover 60 forms a hook 66 on the bottom wall 64 for latching in the latching hole 544 of the main body 50. The hook 66 includes a protruding board 662 perpendicular to the bottom wall 64 and a latching portion 664 at the distal end of the protruding board 662. The latching portion 664 is wedge-shaped and is configured for latching in the latching hole 544 of the main body 50.

During assembly of the electronic device 200, due to the elasticity of the seats 622, the seats 622 can be deformed by an external force, so that the aperture 624 of the seats 622 engagingly receive the protrusion 344 of the shaft unit 30 and the engaging portion 426 of engaging body 40 respectively. The cover 60 is thus fixed with the main body 50.

When folding the cover 60 to the main body 50, the first helical member 22 and the second helical member 24 become more tightly coiled so that the elastic member 20 accumulates elastic force, until the hook 66 is inserted into the notch 542 and the latching portion 664 latches with the latching hole 544. To unfold the cover 60 away from the main body 50, the latching portion 664 is manually pushed out of the latching hole 544 releasing the cover 60. At this time, the elastic member 20 releases its elastic force to urge the cover 60 to rotate away from the main body 50 until the cover 60 returns to its original position in which the first helical member 22 and the second helical member 24 restore to their original states.

The hinge mechanism 100 having the above discussed simple structure is easy to assemble and thus saves a large mount of time during assembly.

It is to be understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A hinge mechanism for interconnecting a cover and a main body of a foldable electronic device, comprising:
a sleeve having two opposite gaps in the interior wall thereof;
a shaft unit including a shaft portion defining a slot, and an end portion formed at an end of the shaft portion;
an elastic member including a central wall and two opposite flanges;
an engaging body;
wherein the shaft unit, the elastic member and the engaging body are mounted into the sleeve, the slot receives the central wall and the two flanges latch into the two gaps correspondingly, the shaft portion is fixed with the engaging body, the elastic member urges the shaft unit return to original position when the shaft unit rotates relative to the sleeve.

2. The hinge mechanism of claim 1, wherein the slot extends along the axis of the shaft portion and divides the shaft portion into two shaft sections, the central wall extends along the central axis of the elastic member, the central wall is received in the slot.

3. The hinge mechanism of claim 1, wherein the engaging body has a circular cavity defined therein, the circular cavity has a dividing wall formed therein, the shaft portion enters into the circular cavity and the slot receives the dividing wall therein.

4. The hinge mechanism of claim 1, wherein the elastic member is a dual helical flat spring.

5. The hinge mechanism of claim 1, wherein the elastic member includes a first helical member, a second helical member, and the central wall connecting the first helical member and the second helical member, the two flanges are oppositely arranged on the exposed longitudinal edges of the first helical member and second helical member.

6. The hinge mechanism of claim 1, wherein the end portion forms a protrusion, the engaging body forms an engaging portion, the protrusion and the engaging portion are configured for assembling with a cover of a foldable electronic device.

7. A foldable electronic device, comprising:
a main body;
a cover;
a hinge mechanism rotatably interconnecting the cover with the main body, the hinge mechanism comprising:
a sleeve having two opposite gaps in the interior wall thereof;
a shaft unit including a shaft portion defining a slot, and an end portion formed at an end of the shaft portion;
an elastic member including a central wall and two opposite flanges;
an engaging body;
wherein the shaft unit, the elastic member and the engaging body are mounted into the sleeve, the slot receives the central wall and the two flanges extend into the two gaps correspondingly, the shaft portion is fixed with the engaging body, the main body forms a latching hole, the cover forms a hook, the cover is folded relative to the main body by the engagement of the latching hole with the hook, releasing the hook and elastic member urges the cover to unfold away from the main body.

8. The foldable electronic device of claim 7, wherein the main body includes a first sidewall and an opposite second sidewall, the sleeve is fixed in the first sidewall, the latching hole is defined on the second sidewall.

9. The foldable electronic device of claim 8, wherein the main body defines a notch adjacent to the second sidewall, the latching hole communicates with the notch, the hook is formed on the bottom wall of the cover, the hook includes a protruding board and a latching portion, the protruding board extends into the notch and the latching portion latches into the latching hole.

10. The foldable electronic device of claim 8, wherein the end portion includes a protrusion, the engaging body includes an engaging portion, the protrusion and the engaging portion are configured to assemble with the cover.

11. The foldable electronic device of claim 10, wherein the cover has two seats formed therein, each of the seats defines an aperture, the apertures engage with the protrusion and the engaging portion respectively.

12. The foldable electronic device of claim 7, wherein the engaging body has a circular cavity defined therein, the circular cavity has a dividing wall formed therein, the shaft portion extends into the circular cavity and the slot receives the dividing wall.

13. The foldable electronic device of claim 7, wherein the elastic member is a dual helical flat spring.
